(19) United States
(12) Patent Application Publication
(10) Pub. No.: US 2004/0078392 A1
(43) Pub. Date: Apr. 22, 2004

(54) Transmission data generation method and transmission data generation equipment

(76) Inventor: Tetsuo Morita, Osaka (JP)

Correspondence Address: MCDERMOTT, WILL & EMERY, 600 13th Street, N.W., Washington, DC, 20005-3096, US

(21) Appl. No.: 10/616,304

(22) Filed: Jul. 10, 2003

Related U.S. Application Data
(60) Provisional application No. 60/395,331, filed on Jul. 12, 2002.

(30) Foreign Application Priority Data
May 9, 2003 (JP) P2003-132292

(51) Int. Cl. G06F 17/00

(52) U.S. Cl. 707/104.1

(57) ABSTRACT

The transmission data generation method comprises a step of setting the size of the fixed block based on the overhead (S3), a step of calculating the playout time of the fixed block based on the size of the fixed block (S4), a step of calculating the playout time of the segment for each segment of the contents based on the playout time of the fixed block (S14), a step of calculating the transmission time of the segment for each segment of the contents based on the calculated playout time of the segment (S18, S19), a step of dividing the contents into segments according to the transmission time of the segment, a step of dividing the segment into blocks, and a step of converting the contents into meta contents by adding overhead for each block, wherein the overhead is set for each segment based on the overhead in the fixed block.

### CROSS-REFERENCE TO RELATED APPLICATION

This application claims priority to Provisional Application Serial No. 60/395331 filed Jul. 12, 2002, which is/are hereby incorporated by reference in its/their entirety.

### BACKGROUND OF THE INVENTION

1. Field of the Invention

The present invention relates to a transmission data generation method and a transmission data generation equipment for generating transmission data for transmitting content.

2. Related Background Art

Recently subscribers of broadband, such as ADSL (Asymmetric Digital Subscriber Line) and FTTH (Fiber To The Home) are rapidly increasing on the Internet and Intranets. Broadband made streaming distribution of various contents possible, and, for example, it became possible to provide video and audio to individual users by VOD (Video On Demand) or to provide a same movie at shifted times in a cinema complex. In such a streaming distribution of contents, FEC (Forward Error Correction) technology (see U.S. patent application Laid-Open No. 2001/0019310) and media division technology (see U.S. patent application Laid-Open No. 2002/0107968) are used.

An example of Forward Error Correction technology is LT (Luby Transform). In Luby Transform, the original data of the contents is created into meta contents adding an overhead. And packets having this meta contents data are distributed. In each packet, equations based on exclusive OR, for determining the original data of the contents, are arranged at random. At the reception side, the original data of the contents can be restored to almost 100% if the meta contents (packets), including the overhead, can be received, and the video and audio of the contents can be regenerated without deterioration.

In media division technology, if the wait time, from the start of a download to playout, is set, the playout time and the download time, from the beginning of the contents, are calculated based on the wait time. This playout time and download time gradually increase from the beginning of the contents, and are calculated until the accumulated time of playout times become the total playout time of the contents. The contents are divided into segments according to the download time (or playout time), and when Luby Transform is combined, the contents are created into meta contents for each segment, and are distributed as packets. At the reception side, the data is sequentially downloaded from the first meta contents segment (packet) of the contents, and the contents can be seamlessly regenerated by sequentially regenerating the downloaded segments, therefore the contents can be viewed/listened to with a very short wait time.

### SUMMARY OF THE INVENTION

The optimum value of the overhead when the contents are created into meta contents varies according to the size of the data. However, the sizes of the contents or segments are arbitrary, so the distribution side sets the overhead to a safe value so that the contents can be regenerated without deterioration, regardless the sizes. In other words, the distribution side sets the overhead to the largest value of the fluctuation range of an overhead (e.g 104 to 105%), so that any size of contents can be restored 100%, adding extra redundant data. Therefore compared with the case of setting the overhead to an optimum value according to the data size, the volume of meta contents transmission data increases and the transmission band increases.

With the foregoing in view, it is an object of the present invention to provide a transmission data generation method and transmission data generation equipment which can optimize the overhead according to the data size.

The transmission data generation method according to the present invention comprises, a fixed block size setting step of setting a size of a fixed block based on the overhead, a segment size calculation step of calculating the size of a segment for each segment of the contents based on the size of the fixed block, a segment division step of dividing the contents into segments according to the calculated size of the segment, a block division step of dividing the divided segment into blocks, and a meta contents creation step for creating the contents into meta contents by adding overhead for each one of the divided blocks, wherein the overhead is set for each segment of the contents based on the overhead in the fixed block.

In this transmission data generation method, the size of a fixed block is set based on the overhead. Then in the transmission data generation method, the size of a segment is calculated for each segment of the contents based on the size of the fixed block. In the transmission data generation method, the contents are divided into segments according to the calculated size of the segment, and the divided segment is further divided into blocks. Finally in the transmission data generation method, the contents are created into meta contents by adding the overhead for each divided block, and generates the transmission data in block units. A segment is comprised of one or more fixed blocks, and the number of fixed blocks increases as the segment size increases. The size of the segment may become an integer multiplication of the size of the fixed block, or may not become an integer multiplication thereof. Therefore the overhead of a segment becomes an overhead in the fixed block when the size of the segment is an integer multiplication of the size of the fixed block, and becomes an overhead in the fixed block and overhead in the remaining block when the size of the segment is not an integer multiplication. In both cases, the overhead of the segment is based on the overhead in the fixed block, and even if the size of the segment is not an integer multiplication, the overhead of the segment becomes a value closer to the overhead in the fixed block as the number of fixed blocks included in the segment increases. Therefore in this transmission data generation method, the overhead is set for each segment based on the overhead in the fixed block. For this, in this transmission data generation method, the size of the fixed block is set considering the overhead thereof, so the overhead of the segment can be set to an optimum value according to the size of the segment (also size of the contents).

The transmission data generation method according to the present invention comprises a fixed block size setting step of setting a size of a fixed block based on the overhead, a fixed block playout time calculation step of calculating the playout time of the fixed block based on the size of the fixed block, a playout time calculation step of calculating the playout time of a segment for each segment of the contents based on the playout time of the fixed block, a transmission time calculation step of calculating the transmission time of a segment for each segment of the contents based on the calculated playout time of the segment, a segment division step of dividing the contents into segments according to the calculated transmission time of the segment, a block division step of dividing the divided segment into blocks, and a meta contents creation step for creating the contents into meta contents by adding overhead for each one of the divided blocks, wherein the overhead is set for each segment of the contents based on the overhead in the fixed block.

In this transmission data generation method, the size of a fixed block is set based on the overhead, and the playout time of the fixed block is calculated based on the size of the fixed block which is set. Then in the transmission data generation method, the playout time of a segment is sequentially calculated for each segment of the contents based on the calculated playout time of the fixed block, and the transmission time of the segment is calculated based on the calculated playout time of the segment. And in the transmission data generation method, the contents are divided into segments according to the calculated transmission time of the segment, and the divided segments are further divided into blocks. Finally in the transmission data generation method, the contents are created into meta contents by adding the overhead for each one of the divided blocks, and generates the transmission data in block units. In this transmission data generation method as well, just like the above mentioned transmission data generation method, the overhead is set for each segment based on the overhead in the fixed block, and the size of this fixed block is set considering this overhead, and the overhead of the segment can be set to an optimum value according to the size. When the size of a segment is actually set, the size of a segment is set based on the wait time at the reception side (initial value of transmission time), so time (playout time and transmission time) is used to indicate the size of a segment or fixed block.

A segment is a division unit when the contents are media-divided, and the playout time and transmission time for each segment are calculated based on the wait time and number of channels, and the contents are divided according to this transmission time or playout time (equivalent to segment size). A fixed block is a unit for creating the contents into meta contents and for transmitting the contents, for which size is fixed. For a size of a fixed block, a size when 64 Mbytes are divided by a multiplier of 2, such as 64 Mbytes, 32 Mbytes, 16 Mbytes and 8 Mbytes, for example, is set. Data is handled not in segment units but in block units, because there are restrictions in programs which must handle data which upper limit for size is defined, and restrictions in hardware, such as memory. If data is handled in segment units, the data size is arbitrary, and the upper limit of the size cannot be defined.

The size of a segment is a value when the transmission time of the segment is multiplied by the transmission rate, or a value when the playout time of the segment is multiplied by the playout rate. The size of a fixed block is a value when the transmission time of the fixed block is multiplied by the transmission rate, or a value when the playout time of the fixed block is multiplied by the playout rate. Therefore the playout time and transmission time are parameters which indicate the size, and the size increases as time becomes longer. The playout time and the transmission time are in proportion to each other, and dividing the data into segments according to the transmission time is equivalent to dividing the data into segments according to the playout time.

In the above transmission data generation method of the present invention, it is preferable that in the fixed block size setting step, the size of the fixed block is set so that the overhead becomes a small value.

In this transmission data generation method, the overhead for each segment is decreased by setting the size of the fixed block such that the overhead becomes a small value. Therefore the transmission data volume for each fixed block (also segment) decreases, and the transmission band can be decreased.

The above mentioned data generation method of the present invention further comprises an variable block setting step of determining the size or playout time of an variable block which cannot be divided by the fixed block, and an overhead in the variable block for each segment of the contents when the size of the segment is not an integer multiplication of the size of the fixed block, wherein when the size of the segment is not an integer multiplication of the size of the fixed block, the overhead for each segment is set based on the overhead in the fixed block and the overhead of the variable block of the segment.

In this transmission data generation method, if the size of the segment does not become an integer multiplication of the size of the fixed block, the size or playout time of an variable block, which is a remaining block which cannot be divided by the fixed block, and the overhead of the variable block, are determined for each segment of the contents. In this case, the overhead of the segment is comprised of the overhead in the fixed block and the overhead in the variable block for each segment. As described above, according to this transmission data generation method, even if the segment cannot be divided by the fixed block size, the overhead can be set for each segment by determining the overhead of the remaining block.

An variable block is a remaining block when the segment is divided by the fixed block size, and the size of an variable block is arbitrary. Therefore for an variable block, overhead differs depending on the size. The size of an variable block is a value when the transmission time of the variable block is multiplied by the transmission rate, or a value when the playout time of the variable block is multiplied by the playout rate.

The above mentioned transmission data generation method of the present invention further comprises a fixed block transmission time calculation step of calculating the transmission time of the fixed block based on the playout time of the fixed block, a fixed block count calculation step of calculating the number of fixed blocks included in the segment for each segment of the contents based on the transmission time of the segment and the transmission time of the fixed block, and a total fixed block playout time calculation step of calculating the playout time for all the fixed blocks included in the segment for each segment of the contents based on the calculated number of fixed blocks and the playout time of the fixed block, wherein in the transmissions time calculation step, the playout time of all the fixed blocks included in the segment is regarded as the playout time of the segment for each segment of the contents if the size of the segment is an integer multiplication of the size of the fixed block, and if the size of the segment is not an integer multiplication of the size of the fixed block, the playout time of the segment is calculated based on the playout time of an variable block of the segment and the playout time of all the fixed blocks included in the segment.

In this transmission data generation method, the playout time of the fixed block is calculated and then the transmission time of the fixed block is calculated based on the playout time of the fixed block. And in the transmission data generation method, the number of fixed blocks included in the segment is calculated for each segment of the contents based on the playout time of the segment and the transmission time of the fixed block, and the playout time of all the fixed blocks included in the segment is calculated from the number of fixed blocks and the playout time of the fixed block. Also in the transmission data generation method, if the size of the segment is an integer multiplication of the size of the fixed block, the playout time of all the fixed blocks included in the segment is regarded as the playout time of the segment for each segment of the contents, and if the size of the segment is not an integer multiplication of the size of the fixed block, the playout time of the segment is calculated based on the playout time of an variable block of the segment and the playout time of all the fixed blocks included in the segment. In this way, according to the transmission data generation method, the number of fixed blocks included in the segment can be easily calculated, and the playout time of the segment can be calculated from the number of fixed blocks.

According to the above mentioned transmission data generation method of the present invention, in the variable block setting step, the product of the playout time of the variable block and the overhead in the variable block is determined for each segment of the contents using the playout time of all the fixed blocks included in the segment and the transmission time of the segment, and the playout time of the variable block and the overhead in the variable block are determined from this product using a predetermined numerical analysis method.

In this transmission data generation method, the playout time of all the fixed blocks included in the segment are calculated for each segment of the contents and then the product of the playout time and the overhead of the variable block using the registration time of all the fixed blocks and the transmission time of the segment, and the playout time and the over head of the variable block are determined from this product using a predetermined numerical analysis method. In this transmission data generation method, the playout time of the variable block is determined considering the overhead thereof, so the overhead of the segment can be set to an optimum value according to the size of the segment (that is size of contents). One equation is established for two variables, the playout time and the overhead of the variable block, and these two variables can be determined by using a numerical analysis method, such as the Newton-Raphson method and a bisection algorithm.

The transmission data generation equipment according to the present invention comprises time calculation means which sets the size of a fixed block based on the overhead, calculates the playout time of the fixed block based on the size of the fixed block, calculates the playout time of a segment for each segment of the contents based on the playout time of the fixed block, and calculates the transmission time of a segment based on the calculated playout time of the segment, division means which divides the contents into segments according to the transmission time of the segment calculated by the time calculation means, and divides the divided segments into blocks, and meta contents means for creating contents into meta contents by adding the overhead for each block divided by the division means, wherein the time calculation means sets the overhead for each segment based on the overhead in the fixed block.

In the above mentioned transmission data generation equipment of the present invention, it is preferable that the time calculation means sets the size of the fixed block so that the overhead becomes a small value.

In the above mentioned transmission data generation equipment of the present invention, when the size of a segment is not an integer multiplication of the size of the fixed block, the time calculation means determines the playout time of an variable block which cannot be divided by the fixed block and the overhead in the variable block, and sets the overhead for each segment based on the overhead in the fixed block and the overhead in the variable block of the segment.

In the above mentioned transmission data generation equipment, functional effects similar to the above mentioned transmission data generation method can be exhibited.

### BRIEF DESCRIPTION OF THE DRAWINGS

FIG. 1 is a diagram depicting a general configuration of an IP multicast type VOD service according to the present embodiment;

FIG. 2 is a diagram depicting the processing in the media division section of the server in FIG. 1;

FIG. 3 is a diagram depicting the relationship between the download time and the playout time when the number of simultaneous reception channels is one;

FIG. 4 is a diagram depicting the relationship between the download time and the playout time when the number of simultaneous reception channels is two;

FIG. 5 is a diagram depicting the relationship between the download time and the playout time when the number of simultaneous reception channels is three;

FIG. 6 is a diagram depicting the relationship between the download time, playout time and streaming rate;

FIG. 7 is a diagram depicting the block division in the media division section of the server in FIG. 1;

FIG. 8 is a diagram depicting the relationship between the data size and overhead in a Luby Transform;

FIG. 9 is a diagram depicting the relationship between the download time, playout time and streaming rate when the overhead is optimized;

FIG. 10 is a diagram depicting the Newton-Raphson method;

FIG. 11 is a diagram depicting the processing in the FEC encoder of the server in FIG. 1;

FIG. 12 is a diagram depicting meta contents creation;

FIG. 13 is a flow chart depicting the computing processing of the playout time and download time according to the present embodiment; and

FIG. 14 is a diagram depicting the relationship between the packet loss tolerance and multicast band.

### DESCRIPTION OF THE PREFERRED EMBODIMENTS

Embodiments of the transmission data generation method and transmission data generation equipment according to the present invention will now be described with reference to the accompanying drawings.

In the present embodiment, the transmission data generation method and transmission data generation equipment according to the present invention are applied to a server in an IP (Internet Protocol) multicast type VOD service. In the IP multicast type VOD service according to the present embodiment, the server stream-distributes the contents to many personal computers via the Internet, and the personal computers can regenerate the contents seamlessly with a short wait time. The server according to the present embodiment is a VOD server, which stream-distributes the contents combining meta contents creation by combination of Luby Transform and media division.

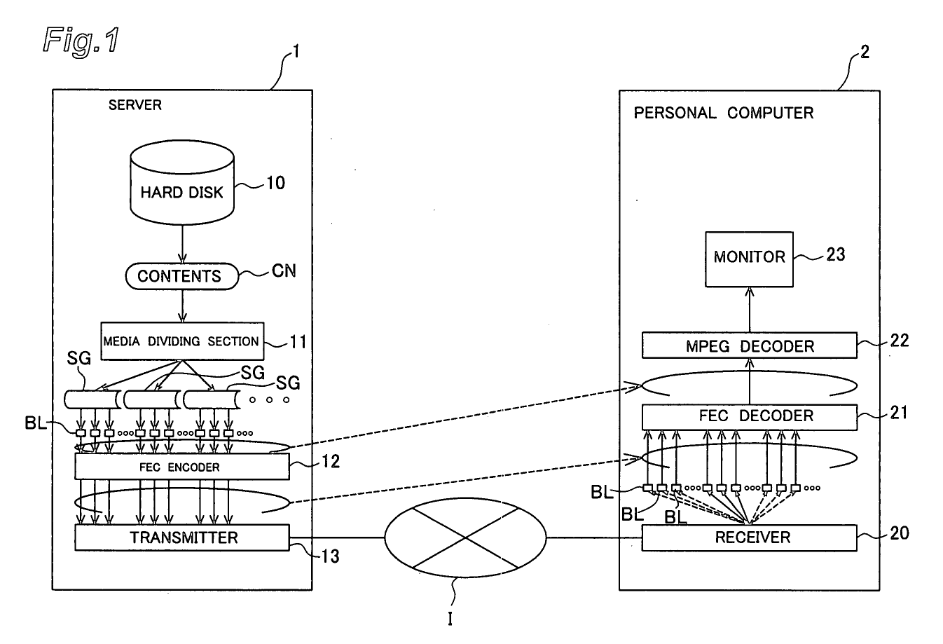

The configuration of the IP multicast type VOD service will now be described with reference to FIG. 1. FIG. 1 is a diagram depicting the general configuration of the IP multicast type VOD service according to the present embodiment. In FIG. 1, there is only one personal computer, but actually there are many personal computers.

In the IP multicast VOD service, the server 1 (transmission data generation equipment) stream-distributes the contents CN to the personal computer 2 via the Internet I. In the server 1, media division is performed on the contents, meta contents are created, and packets (transmission data) are generated for each segment, so as to implement high quality and high-speed distribution. The personal computer 2 sequentially receives packets from the server 1 for each segment, and sequentially regenerates the received packets for each segment, so that even a long time contents CN can be regenerated seamlessly with a short wait time.

In the server 1, many contents CN . . . are stored on the hard disk 10, and the contents CN to be created into packets is retrieved from the hard disk 10 by the driver (not illustrated). The contents CN at least includes the data of a moving picture (images), and the digital data of the moving picture is compressed and stored by MPEG (Moving Picture Experts Group) 2, for example. The contents CN may include such data as voice and characters, other than moving pictures. The general size of the contents CN can be expressed by the total playout time S from the first to the last of the contents CN, and by the streaming rate R which is the speed during playout.

Further in the server 1, the media division section 11 (time calculation means, division means) divides the contents CN into the segments SG, . . . , and further divides each segment SG into the blocks BL, . . . . Also in the server 1, the FEC encoder 12 (meta contents means) creates the contents CN into the meta contents for each block BL, and generates a packet which is comprised of meta contents data (in block units). And in the server 1, the transmitter 13 distributes the packets via the Internet I. The media division section 11 and the FEC encoder 12 are constructed in software by executing dedicated programs by computer. Processing in the media division section 11 and the FEC encoder 12 will be described in detail later.

In the personal computer 2, the receiver 20 downloads the packets in block units for each segment. And in the personal computer 2, the FEC decoder 21 restores the meta contents data included in the packets to the original data of the contents CN. Also in the personal computer 2, the MPEG decoder 22 decompresses the compressed original data. And in the personal computer 2, the monitor 23 continuously regenerates the contents CN for each segment SG.

Before describing the processing by the media division section 11 and the FEC encoder 12, the parameters used for the media division section 11 and the FEC encoder 12 will be shown below. It is assumed that the wait time, from the start of download in the personal computer 2 to the start of playout, is w, the streaming rate of the contents CN is R, the total playout time is S, the overhead when the meta contents are created is e, the packet loss tolerance when the contents CN are transmitted from the server 1 to the personal computer 2 is L, the maximum reception rate is Rₘₐₓ, the number of simultaneous reception channels is C, and the number of multicast groups is n. The effective streaming rate R_{eff}, where the overhead e and the packet loss tolerance L are added, can be determined by the equation (1), and this indicates the streaming rate of the contents where redundancy is added. The streaming rate ratio m can be determined by the equation (2), and this indicates the ratio of the effective streaming rate R_{eff} to the maximum reception rate Rₘₐₓ. The transmission rate R per channel can be determined by the equation (3).

$$\begin{matrix} {R}_{eff} = \frac{e \times R}{1 - L} & ( 1 ) \\ m = \frac{{R}_{max}}{{R}_{eff}} = \frac{{R}_{max} \times ( 1 - L )}{e \times R} & ( 2 ) \\ {R}_{s} = \frac{{R}_{max}}{C} = \frac{m \times {R}_{eff}}{C} & ( 3 )\end{matrix}$$

The unit of the packet loss tolerance L is a percentage [%], but in each equation used for the present embodiment, a 1 or less numeric (e.g. 0.1 for 10%) is used according to the percentage. The unit of the overhead e is also a percentage [%], but in each equation used for the present embodiment, a 1.04 to 1.05 numeric is used according to the percentage.

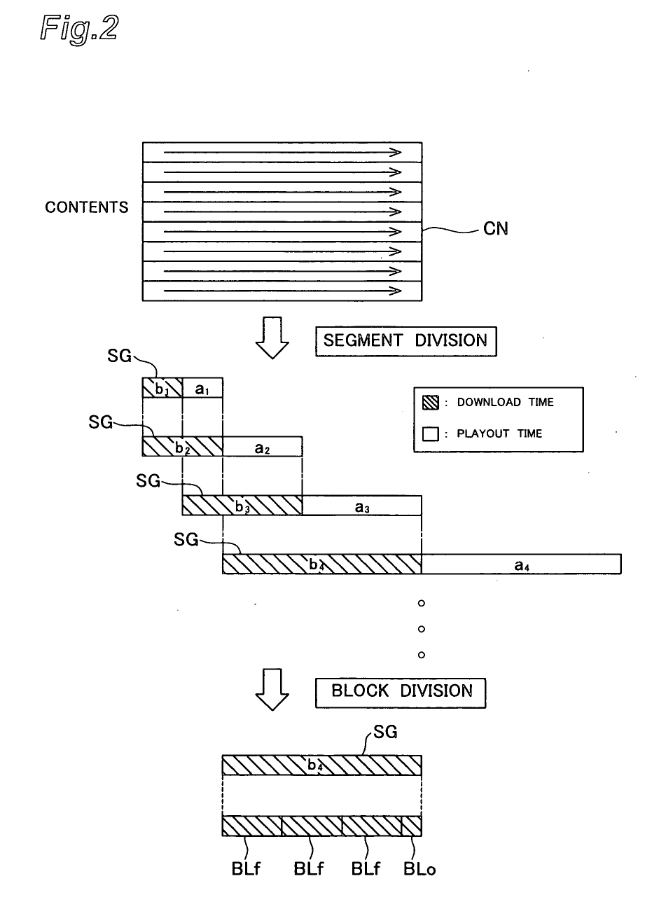

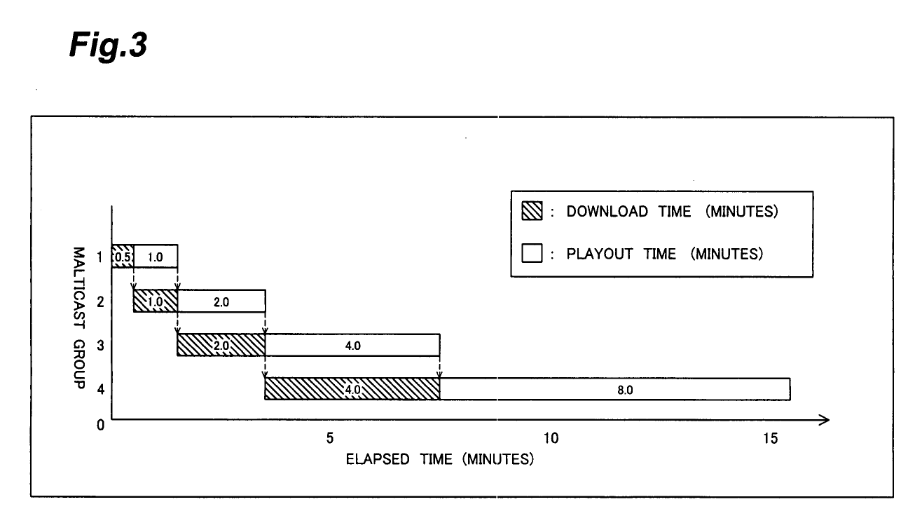

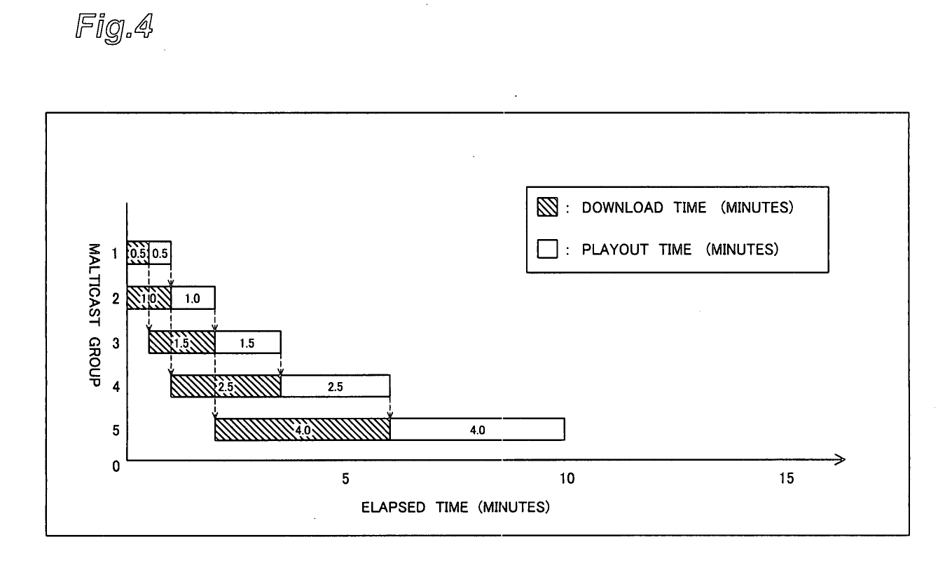

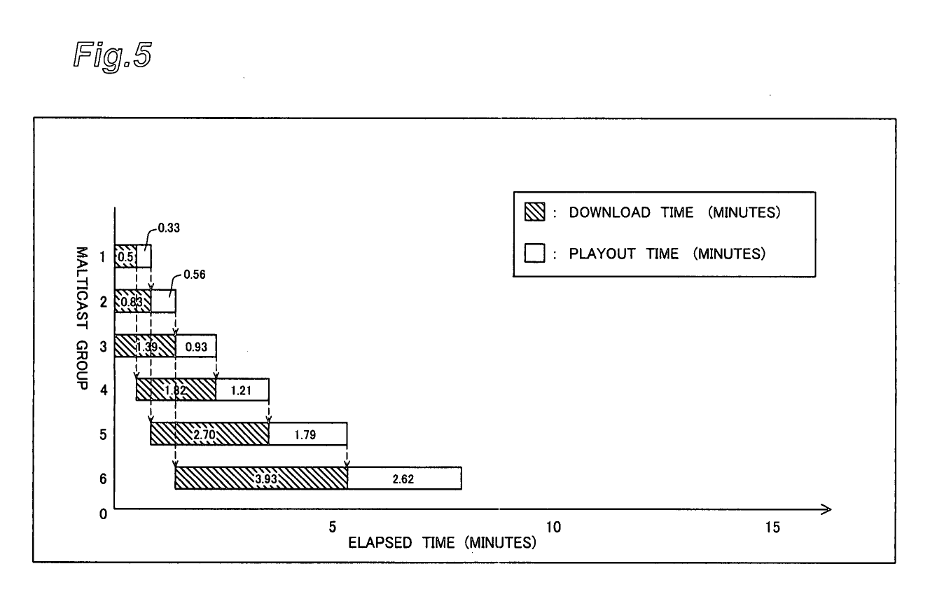

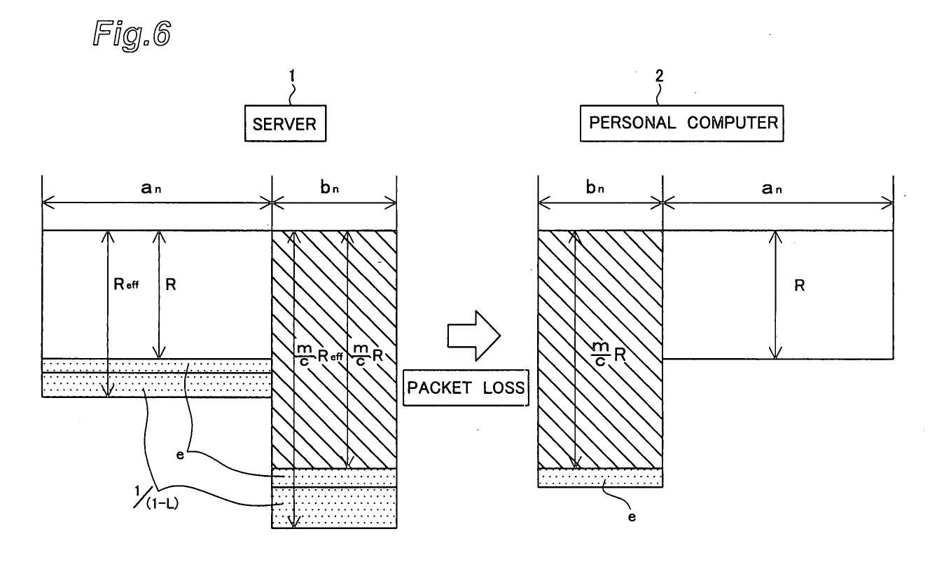

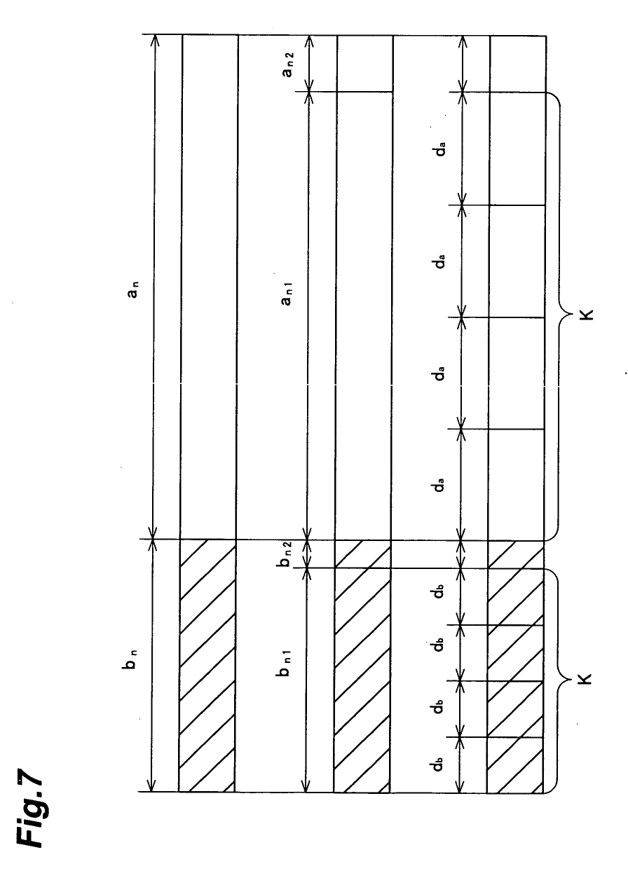

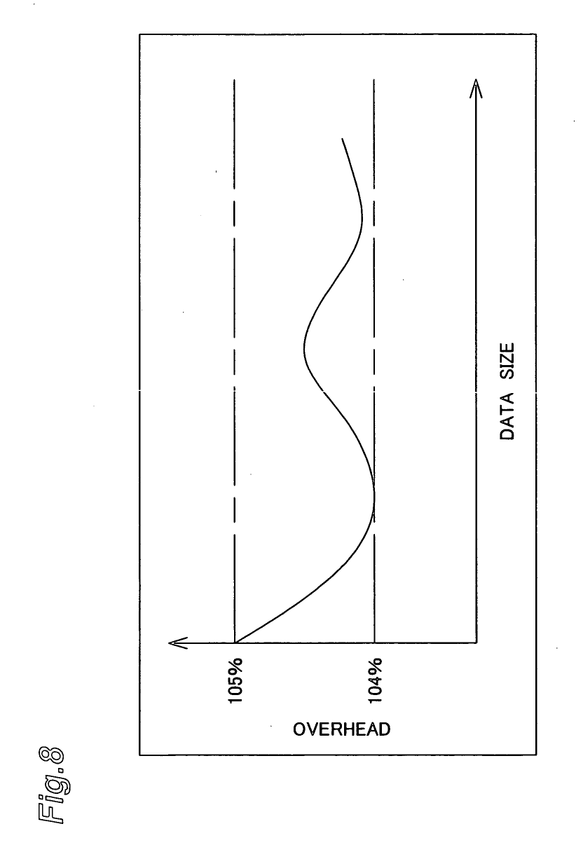

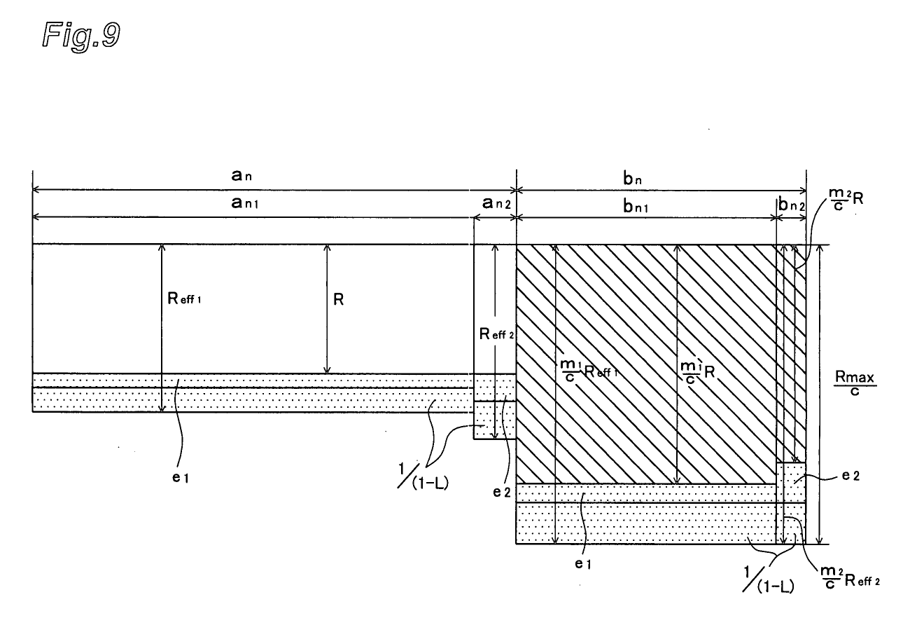

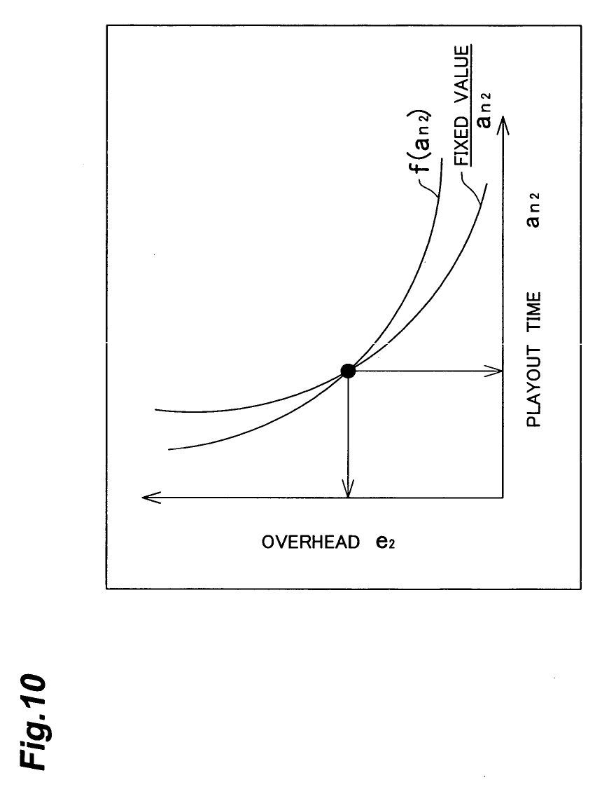

Processing in the media division section 11 will now be described in detail referring to FIG. 1-FIG. 10. FIG. 2 is a diagram depicting the processing in the media division section. FIG. 3 is a diagram depicting the relationship between the download time and the playout time when the number of simultaneous reception channels is 1. FIG. 4 is a diagram depicting the relationship between the download time and the playout time when the number of simultaneous reception channels is 2. FIG. 5 is a diagram depicting the relationship between the download time and the playout time when the number of simultaneous reception channels is 3. FIG. 6 is a diagram depicting the relationship between the download time, playout time, and streaming rate. FIG. 7 is a diagram depicting the block division in the media division section. FIG. 8 is a diagram depicting the relationship between the data size and overhead in a Luby Transform. FIG. 9 is a diagram depicting the relationship between the download time, playout time, and streaming rate when the overhead is optimized. And FIG. 10 is a diagram depicting the Newton-Raphson method.

The media division section 11 shown in FIG. 2 divides the contents CN into segments SG, and further divides the segments SG into the fixed blocks BLf and an variable block BLo, which is a remaining block that cannot be divided by the fixed block BLf. The segment SG is a division unit to media-divide the contents CN for stream-distributing the contents seamlessly with a wait time w, which is set. The size of the segment SG is an arbitrary size, and gradually increases from the beginning of the contents CN. The fixed block BLf is a unit when the contents CN are created into meta contents and is transmitted where the size is fixed. The size of the fixed block BLf is determined by the restriction to read the data into the memory of the playout device (personal computer 2). The variable block BLo is a remaining block, which could not be divided by the fixed block BLf, when the segment SG is divided by the fixed block BLf. The size of the variable block BLo is an arbitrary size, which is smaller than the size of the fixed block BLf. If the segment SG can be precisely divided by the fixed block BLf, the variable block BLo does not exist in this segment SG.

The contents are divided into segments SG for making seamless playout possible by merely waiting during the wait time w, which has been set, from the start of download, by repeatedly executing download and playout in segment units at the reception side. The size of the segment SG can be expressed by the product of the download times b₁, b₂, . . . and the transmission rate (transmission speed) or the playout times a₁, a₂, . . . and the streaming rate (playout rate). The transmission rate and the streaming rate are constant speeds respectively, so the segment SG . . . is divided according to the download times b₁, b₂, . . . corresponding to the size. Time when all the playout times a₁, a₂, . . . are added is the total playout time S of the contents CN. The download times b₁, b₂, . . . and the playout times a₁, a₂, . . . are in a proportional relationship, and the division according to the download times b₁, b₂, . . . has the same division result as the division according to the playout times a₁, a₂, . . .

The segment SG divided into the blocks BLf and BLo is for defining the upper limit of the data volume to be handled by the server 1 and the personal computer 2. This is because the server 1 and the personal computer 2 have program limitations and hardware limitations, such as memory, with the data volume to be handled.

The methods of segment division in the media division section 11 based on the playout time and the download time will be described using three examples with reference to FIG. 3 to FIG. 5. In the examples shown in FIG. 3 to FIG. 5, it is assumed that the wait time w is 30 seconds, the streaming rate R is 600 kbps, the overhead e is 1.05 (105%), the packet loss tolerance L is 10%, and the maximum reception rate Rₘₐₓ is 1400 kbps. In this case, the effective streaming rate R_{eff} is 700 kbps by the equation (1). And the streaming rate ratio m is 2 by the equation (2).

At first in the media division section 11, the wait time w=30 seconds (=0.5 minutes) is set for the download time b, of the first segment as the initial value of the download time. In the media division section 11, the playout time aₙ of each segment is sequentially computed, and the download time bₙ₊₁ of the next segment is sequentially computed from the calculated 1 or more of the playout times aₙ, aₙ₋₁, . . . At this time, the playout time is set so that playout does not stop between successive segments, and the download time of the next segment is set during the playout time of 1 or more segments. And the playout time and the download time are sequentially set until the integrated time of the playout times a₁, . . . aₙ becomes the total playout times. The wait time w may be set by the user at the personal computer 2, or may be set in advance at the server 1 side.

In the example in FIG. 3, the number of simultaneous reception channels C is 1, so the download time of the next segment is set for the playout time of one segment. The transmission rate R, per channel is 1400 kbps by the equation (3), which is double the effective streaming rate R_{eff}. Therefore the playout time is double the download time in each segment. At first, if the download time of the first segment is set to 0.5 minutes, then the download time of the second segment is set to one minute 0.5 minutes later, and the download time of the third segment is set to two minutes 1.5 minutes later.

In the example of FIG. 4, the number of simultaneous reception channels C is 2, so the download time of the next segment is set for the playout time of two segments. The transmission rate Rₛ per channel is 700 kbps by the equation (3), which is one times the effective streaming rate R_{eff}. Therefore the playout time is one times the download time in each segment. At first, if the download time of the first segment is set to 0.5 minutes and the playout time to 0.5 minutes, and also the download time of the second segment is set to one minute, then the download time of the third segment is set to 1.5 (=0.5+1) minutes 0.5 minutes later, and the download time of the fourth segment is set to 2.5 (=1+0.5) minutes one minute later, and the download time of the fifth segment is set to 4.0 (=1.5+2.5) minutes two minutes later.

In the example of FIG. 5, the number of simultaneous reception channels C is 3, so the download time of the next segment is set for the playout time of three segments. The effective transmission rate Rₛ per channel is 467 kbps by the equation (3), which is 2/3 times the effective streaming rate R_{eff}. Therefore the playout time is 2/3 times the download time in each segment. At first, if the download time of the first segment is set to 0.5 minutes and the playout time to 0.33 minutes, the download time of the second segment to 0.83 minutes and the playout time to 0.56 minutes, and also the download time of the third segment to 1.39 minutes, then the download time of the fourth segment is set to 1.82 (=0.33+0.56+0.93) minutes 0.5 minutes later, the download time of the fifth segment is set to 2.70 (=0.56+0.93+1.21) minutes 0.83 minutes later, and the download time of the sixth segment is set to 3.93 (=0.93+1.21+1.79) minutes 1.39 minutes later.

When the download time of the n-th segment is bₙ, and the playout time thereof is aₙ, the relationship between the download time bₙ and the playout time aₙ becomes the relationship shown in the equation (4). The media division section 11 computes the download time bₙ from the playout times before the n-th segment, aₙ₋₁, aₙ₋₂, . . . by the equation (5) or equation (6).

$$\begin{matrix}{a}_{n} = \frac{m}{C} \times {b}_{n} & ( 4 ) \\ In case of n - C < 1 , {b}_{n} = {b}_{1} + {\sum }_{i = 1}^{n - 1} {a}_{1} & ( 5 ) \\ In case of n - C \leq 1 , {b}_{n} = {\sum }_{i = n - C}^{n - 1} {a}_{1} & ( 6 )\end{matrix}$$

As the equation (5) and equation (6) show, the download time bₙ of the segment can be determined by adding the already computed playout times aₙ₋₁, aₙ₋₂, . . . , and the number of playout times to be added differs depending on the number of channels C.

Now the relationship between the playout time aₙ, download time bₙ, streaming rate R, and effective streaming rate R_{eff} in each segment will be described with reference to FIG. 6. In each segment, the playout data and the download data have the same size, so the product of the playout time aₙ and the streaming rate R (see the white area in FIG. 6) is the same as the product of the download time bₙ and the transmission rate mR/C per channel (see area indicated by the diagonal line in FIG. 6), as shown in the equation (7). Also to allow the personal computer 2 to restore to the original data of the contents CN 100%, the server 1 side adds the redundant data, due to the overhead e (see the dotted area indicated by e in FIG. 6) for creating meta contents in each segment and the packet loss tolerance L (see the dotted area indicated by 1/(1-L) in FIG. 6) against the packet loss during transmission. Therefore in each segment, the product of the playout time aₙ and the effective streaming rate R_{eff} is the same as the product of the download time bₙ and the effective transmission rate mR_{eff}/C per channel, as shown in the equation (8). For the overhead e, an optimum value as small as possible is set, 104% to 105%, for example. For the packet loss tolerance L, a value to be assumed in the network, between the server 1 and the personal computer 2, is set, where the lower limit is 0% and the upper limit is less than 50%, and is 10%, for example.

$$\begin{matrix}R \times {a}_{n} = \frac{m \times R}{C} \times {b}_{n} & ( 7 ) \\ {R}_{eff} \times {a}_{n} = \frac{m \times {R}_{eff}}{C} \times {b}_{n} & ( 8 )\end{matrix}$$

The equation (7) and equation (8) show that the data size, which is the product of the time and rate, is the same for the playout data and the download data.

At the personal computer 2 side, however, the packet corresponding to the packet loss tolerance L has been lost during transmission, so the redundant data corresponding to the packet loss tolerance L has decreased. Also At the personal computer 2 side, If the meta contents data, which includes the redundant data corresponding to the overhead e, can be received, then the original data can be almost 100%. restored.

Now the method of block division in the media division section 11 will be described with reference to FIG. 2 and FIG. 7 to FIG. 10. In the media division section 11, the size of the fixed block BLf is set first (see FIG. 2). The size Bₛ of the fixed block BLf is set such that the value of the overhead e₁ of the fixed block becomes a small value. The overhead in meta contents creations fluctuates in a 104 to 105% range, for example, depending on the data size, as shown in FIG. 8. For example, as a result of simulation and experiment, the overhead e fluctuates in data size (64 Mbytes, 32 Mbytes, 16 Mbytes, . . . ), which is 64 Mbytes, and is divided by a multiple of 2. So in the media division section 11, 64 Mbytes, where the overhead e₁ becomes 104%, is set as the size Bₛ of the fixed block BLf. In this case, in the server 1, the 64 Mbytes of original data is created into meta contents by adding a 4% overhead, and if the meta contents data, which includes a 4% redundant data, can be received by the personal computer 2, then the original data can be almost 100% restored. In this way, in the server 1, the overhead e₁ of the fixed block is set to a value as small as possible to decrease the redundant data volume, and to decrease the data volume in a fixed block.

Then the media division section 11 computes the playout time dₐ of the fixed block from the fixed block size Bₛ by the equation (9) (see FIG. 7). Then the media division section 11 computes the streaming ratio m₁ in the fixed block from the overhead e₁ of the fixed block by the equation (10). Also the media division section 11 computes the download time d_{b} of the fixed block from the playout time dₐ and the streaming rate ratio m₁ of the fixed block by the equation (11) (see FIG. 7). If the download time db becomes larger than the download time bₙ of the segment, the fixed block size Bₛ is set to half size again. If the download time d_{b} is still larger even if the fixed block size Bₛ is set to half, the fixed block size Bₛ is further divided into two.

$$\begin{matrix}{d}_{a} = \frac{{B}_{s}}{R} & ( 9 ) \\ {m}_{1} = \frac{{R}_{max} \times ( 1 - L )}{{e}_{1} \times R} & ( 10 ) \\ {d}_{b} = \frac{C}{{m}_{1}} \times {d}_{a} & ( 11 )\end{matrix}$$

The values of the playout time da and the download time d_{b} of this fixed block are the same for all the segments, since the fixed block size Bₛ is common for all the segments.

And the media division section 11 computes the number of fixed blocks k included in each segment for each segment by the equation (12) (see FIG. 7) Then the media division section 11 computes the total playout time aₙ₁ of all the fixed blocks included in each segment for each segment by the equation (13) (see FIG. 7). Also the media division section 11 computes the total download time bₙ₁ of all the fixed blocks included in each segment for each segment by the equation (14), and computes the download time bₙ₂ in an variable block of each segment by the equation (15) (see FIG. 7).

$$k = INT [ \frac{{b}_{n}}{{d}_{b}} ] \qquad ( 12 )$$

aₙ₁=k×dₐ (13)

bₙ₁=k×d_{b} (14)

bₙ₂=bₙ−bₙ₁=bₙ−k×d_{b} (15)

INT [ ] is an integral function and can determine the integer value when a fraction is discarded after a numerator is divided by a denominator.

Here the playout time aₙ of the segment cannot be determined unless the generation time aₙ₂ of an variable block in the segment is known. Also the overhead e in the segment cannot be determined unless the overhead e₂ of an variable block in the segment is known. So the media division section 11 determines the playout time aₙ₂ and the overhead e₂ of the variable block.

The overhead e₁ of the fixed block is fixed to a small value in the fluctuation range of the overhead, but the overhead e₂ of the variable block is larger than the overhead e₁, since the overhead e₂ fluctuates according to the size of the variable block (see FIG. 9). Since the size of the download data and the playout data are the same, the total playout time aₙ₁ and the total download time bₙ₁ of all the fixed blocks included in the segment have the relationship shown in the equation (16), and the playout time aₙ₂ and the download time bₙ₂ of an variable block of the segment have the relationship shown in the equation (17) (see FIG. 9). From the equation (16) and the equation (17), the download time bₙ of the segment, the total playout time aₙ₁ of the fixed block, and the playout time aₙ₂ of the variable block have the relationship shown in the equation (18). The effective streaming rate R_{eff1} in an fixed block, where the overhead e₁ and the packet loss tolerance L have been added, can be computed by the equation (19), and the effective streaming rate R_{eff2} in an variable block, where the overhead e₂ and the pocket loss tolerance L have been added, can be computed by the equation (20) (see FIG. 9).

$$\begin{matrix}{b}_{n1} = \frac{C}{{m}_{1}} \times {a}_{n1} & ( 16 ) \\ {b}_{n2} = \frac{C}{{m}_{2}} \times {a}_{n2} & ( 17 ) \\ {b}_{n} = {b}_{n1} + {b}_{n2} = \frac{C}{{m}_{1}} \times {a}_{n1} + \frac{C}{{m}_{2}} \times {a}_{n2} & ( 18 ) \\ {R}_{eff1} = \frac{{e}_{1} \times R}{1 - L} & ( 19 ) \\ {R}_{eff2} = \frac{{e}_{2} \times R}{1 - L} & ( 20 )\end{matrix}$$

Therefore the streaming rate ratio m₁ in the fixed block can be computed by the equation (21), and the streaming rate ratio m₂ in an variable block can be computed by the equation (22). If these streaming rate ratios m₁ and m₂ are substituted for the equation (18), the equation (23) is established. This equation (23) is transformed into the equation (24) so as to be an equation to compute the product of the overhead e₂ and the playout time aₙ₂ in the variable block.

$$\begin{matrix}{m}_{1} = \frac{{R}_{max}}{{R}_{eff1}} = \frac{{R}_{max} \times ( 1 - L )}{{e}_{1} \times R} & ( 21 ) \\ {m}_{2} = \frac{{R}_{max}}{{R}_{eff2}} = \frac{{R}_{max} \times ( 1 - L )}{{e}_{2} \times R} & ( 22 ) \\ {b}_{n} = \frac{{e}_{1} \times R \times C}{{R}_{max} \times ( 1 - L )} \times {a}_{n1} + \frac{{e}_{2} \times R \times C}{{R}_{max} \times ( 1 - L )} \times {a}_{n2} & ( 23 ) \\ = \frac{R \times C}{{R}_{max} \times ( 1 - L )} ( {e}_{1} \times {a}_{n1} + {e}_{2} \times {a}_{n2} ) & \\ {e}_{2} {a}_{n2} = \frac{{b}_{n} \times {R}_{max} \times ( 1 - L )}{R \times C} - {e}_{1} \times {a}_{n1} & ( 24 )\end{matrix}$$

The total playout time aₙ₁ of the fixed blocks can be computed by the equation (13), the download time bₙ of the segment can be computed by the equations (5) and (6), and the overhead e₁ of the fixed block has been defined when the fixed block size Bₛ is set. Therefore all the parameters at the right hand side of the equation (24) are known, and the right hand side can be computed. In other words, the product of the overhead e₂ and the playout time aₙ₂ in an variable block can be computed for each segment, and becomes a constant value.

Therefore the overhead e₂ in an variable block becomes a function of the playout time aₙ₂, and becomes the relationship shown in the equation (25). The equation (26) is established from the equation (24) and the equation (25).

e₂=f(aₙ₂) (25)

$$f ( {a}_{n2} ) = \frac{Fixed Value}{{a}_{n2}} \qquad ( 26 )$$

Here the playout time aₙ₂ and the overhead e₂ in an variable block can be uniquely determined by using the Newton-Raphson method (see FIG. 10). The media division section 11 determines the playout time aₙ₂ and the overhead e₂ in the variable block using the Newton-Raphson method after computing the right hand side of the equation (24). In the Newton-Raphson method, a value close to a value which is uniquely determined (=f (aₙ₂)) (e.g. 104.5% which is the median of 104 to 105%) is set as the initial value of the overhead e₂ (=f(aₙ₂)), and the overhead e₂ is determined by gradually converging from the initial value. In the server 1, the overhead e₂ of the variable block is set to an optimum value for each segment, the redundant data volume is decreased, and the data volume in the variable block is decreased.

aₙ=aₙ₁+aₙ₂ (27)

And the media division section 11 computes the playout time aₙ of the segment from the total playout time aₙ₁ of the fixed block and the playout time aₙ₂ of an variable block for each segment by the equation (27).

$$\begin{matrix}{e}_{ave} = \frac{{e}_{1} \times {a}_{n1} + {e}_{2} \times {a}_{n2}}{{a}_{n1} + {a}_{n2}} & ( 28 ) \\ {m}_{ave} = \frac{{R}_{max} \times ( 1 - L )}{{e}_{ave} \times R} & ( 29 ) \\ {a}_{n} = \frac{{m}_{ave}}{C} \times {b}_{n} = \frac{{R}_{max} \times ( 1 - L )}{{e}_{ave} \times R \times C} \times {b}_{n} & ( 30 )\end{matrix}$$

Alternatively, the media division section 11 computes the average value eₐᵥₑ of the overhead in the segment by the equation (28), and computes the average value mₐᵥₑ of the streaming rate ratio in the segment by the equation (29). And the media division section 11 computes the playout time aₙ of the segment using the average value eₐᵥₑ of the overhead and the average value mₐᵥₑ of the streaming rate ratio by the equation (30).

In this way, the media division section 11 computes the playout time aₙ of each segment and computes the download time bₙ₊₁ of the next segment from the already calculated playout times aₙ, aₙ₋₁, . . . of the segment. During this computing step, the size Bₛ and the overhead e₁ of the fixed block are set, and the playout time dₐ and the download time d_{b} of the fixed block are computed. Then for each segment, the total playout time aₙ₁ and the total download time bₙ₁ of all the fixed blocks included in the segment and the download time bₙ₂ of an variable block are computed. Also for each segment, the overhead e₂ and the playout time aₙ₂ of the variable block are determined.

Then, the media division section 11 divides the contents CN into segments SG, . . . according to the download time bₙ (or playout time aₙ) of each segment (see FIG. 2). Also the media division section 11 divides each segment into fixed blocks BLf, . . . and an variable block BLo by the download time d_{b} (or the playout time dₐ) of the fixed block and the download time bₙ₂ (or the playout time aₙ₂) of the variable block (see FIG. 2). This division may be performed each time the download time bₙ of each segment is computed, or may be performed after computing the download times b₁, b₂, . . . of all the segments.

The overhead e in each segment is an average value eₐᵥₑ of the overhead which is computed by the equation (28), and is an optimum value according to the size of the segment. The average value eₐᵥₑ of the overhead is influenced by the overhead e₁ (=104%) of the fixed block and is 104.5% or less, and becomes closer to 104% as the number of fixed blocks k included in each segment increases.

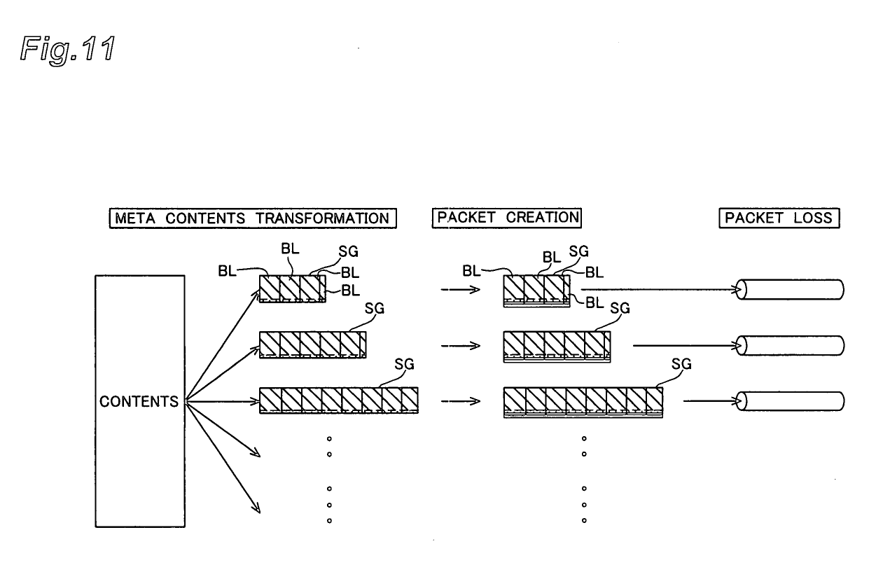

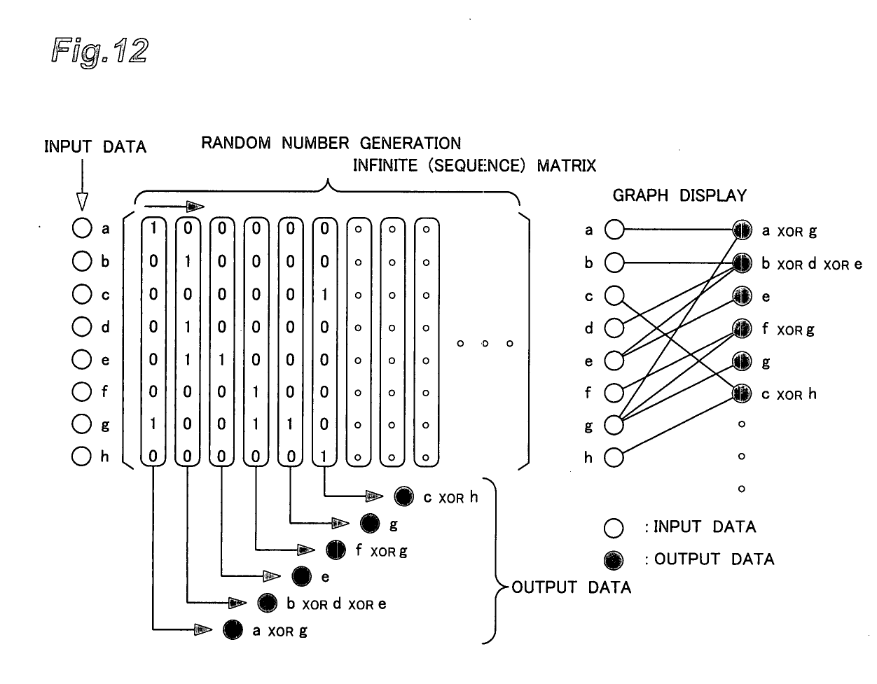

Processing in the FEC encoder 12 will now be described in detail with reference to FIG. 1, FIG. 11 and FIG. 12. FIG. 11 is a diagram depicting processing in the FEC encoder. FIG. 12 is a diagram depicting meta contents creation.

In the FEC encoder 12, the original data of the contents CN is created into meta contents in block BL units for each segment SG, . . . shown in FIG. 11. At this time, in the meta contents data, the redundant data for the overhead e and the packet loss tolerance L (dotted area in FIG. 11) has been added. Also in the FEC encoder 12, an IP packet header is added to the meta contents data in block BL units (horizontal line area in FIG. 11) as shown in FIG. 11, so as to generate packets in block units. The data size after packeting is (1086/1024) times, for example, of the data size after meta contents creation.

Meta contents creation by the Luby Transform will be described with reference to FIG. 12. FIG. 12 shows an example when there are ten input data, a to h, corresponding to the original data of the contents. In Luby Transform, random numbers are generated for each input data a to h. And an equation based on exclusive OR is created for each column (e.g. aXORg in the case of the first column) as output data, and this equation becomes the meta contents data.

Basically if equations (output data) for the number of input data are available, then equations can be solved and input data can be restored. In a Luby Transform, however, meta contents data are randomly rearranged, and the redundant data is included in this randomly rearranged meta contents data. Therefore the input data cannot be restored 100% with the equations (output data) for the number of input data. So in a Luby Transform, the overhead e is set, and meta contents is generated from the equations (output data) for the number of input data to which overhead e is added. For example, if the overhead e is 104%, the meta contents is comprised of 104 output data (equations) when the number of input data is 100.

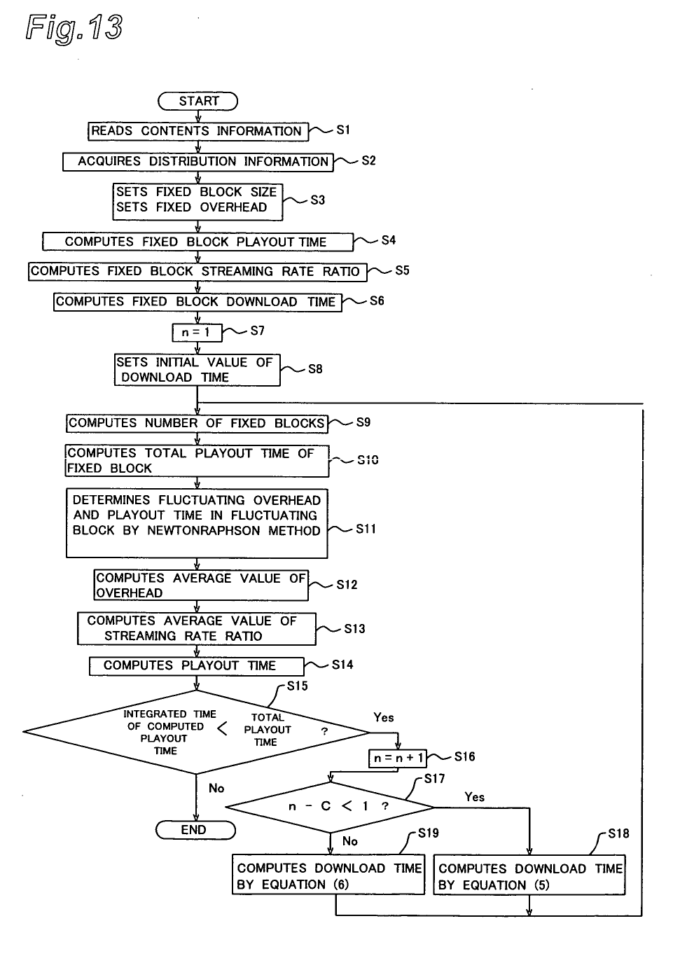

Now operation of the server 1 will be described with reference to FIG. 1. In particular, the computing processing of the playout time and the download time in the media division section 11 will be described according to the flow chart in FIG. 13. FIG. 13 is a flowchart depicting the computing processing of the playout time and the download time according to the present embodiment.

The server 1 reads the contents CN from the hard disk 10 to stream-distribute certain contents CN. Each contents CN has such contents information as contents size Cs, streaming rate R and total playout time S, and this information is also stored on the hard disk 10.

The server 1 first reads the contents information for media division (S1). Then the server 1 acquires such distribution information as the wait time w, packet loss tolerance L, maximum reception rate Rₘₐₓ and number of channels C (S2). For the acquisition of the distribution information, information may be acquired and stored on the hard disk 10 in advance, and this information is read from the hard disk 10, or the information may be acquired when the server 1 is connected with the personal computer 2 via the Internet I.

When various information is acquired, the server 1 sets the fixed block size Bₛ and the overhead e₁, so that the overhead e₁ of the fixed block becomes a value as small as possible (S3) (see FIG. 8). And the server 1 computes the playout time dₐ of the fixed block from the fixed block size Bₛ by the equation (9) (S4) (see FIG. 7). Also the server 1 computes the streaming rate ratio m₁ of the fixed block from the overhead e₁ by the equation (10) (S5). Then the server 1 computes the download time d_{b} of the fixed block from the playout time dₐ, and the streaming rate ratio m₁ by the equation (11) (S6) (see FIG. 7).

Then the server 1 sets 1 to n, which indicates the order of the segment to be processed from the beginning of the contents CN (S7). And the server 1 sets the wait time w as the download time b₁ (initial value) of the first segment (S8). The processing thus far is executed only once, and the processing hereafter is repeatedly executed for each segment.

The server 1 computes the number of fixed blocks k from the download time bₙ of the segment and the download time d_{b} of the fixed block by the equation (12) (S9) (see FIG. 7). The download time bₙ is initially set in the processing of S8 if n is 1, and is computed in the processing of S18 or S19 if n is not 1. Then the server 1 computes the total playout time aₙ₁ of all the fixed blocks included in the segment from the playout time dₐ of the fixed block and the number of fixed blocks k by the equation (13) (S10) (see FIG. 7).

The server 1 determines the right hand side value of the equation (24) (that is, the product of the overhead e₂ and the playout time aₙ₂ of an variable block) using the download time bₙ, the overhead e₁ of the fixed block, and the total playout time aₙ₁. And the server 1 determines the overhead e₂ and the playout aₙ₂ of the variable block using the right hand side value of this equation (24) by the Newton-Raphson method (S11) (see FIG. 10).

The server 1 computes the average value eₐᵥₑ of the overhead in the segment from the overhead e₁ of the fixed block and the overhead e₂ of an variable block by the equation (28) (S12). Also the server 1 computes the average value mₐᵥₑ of the streaming rate ratio in the segment from the average value eₐᵥₑ of the overhead by the equation (29) (S13).

And the server 1 computes the playout time aₙ of the segment from the average value eₐᵥₑ of the overhead or the average value mₐᵥₑ of the streaming rate ratio by the equation (30) (S14). Or the server 1 computes the playout time aₙ of the segment from the total playout time aₙ₁ of the fixed blocks and the playout time aₙ₂ of an variable block by the equation (27) (S14).

In order to judge whether the computing processing for the download time and the playout time is ended, the server 1 judges whether the integrated time of the playout times a₁ to aₙ, which have been computed thus far, is less than the total playout time S of the contents CN (S15). If it is judged that the integrated time is the total playout time S or more, the server 1 ends the computing processing for the download time and the playout time.

If it is judged that the integrated time is less than the total playout time S, on the other hand, the server 1 adds 1 to n and moves to the computing processing for the next segment (S16).

And the server 1 judges whether (n-number of channels C) is less than 1 (S17). If it is judged that (n-number of channels C) is less than 1, the server 1 computes the download time bₙ of the next segment from the initial value b₁ of the download time and the already computed playout times a₁, a₂, . . . by the equation (5) (S18) If it is judged that (n-number of channels C) is 1 or more, on the other hand, the server 1 computes the download time bₙ of the next segment from the already computed playout times aₙ₋₁, aₙ₋₂, . . . by the equation (6) (S19). When the download time bₙ is computed, the server 1 returns to S9 and continues processing.

When the computing processing for the download time and the playout time for the contents CN ends, the server 1 sequentially divides the contents CN into the segments SG according to the download time bₙ (or the playout time aₙ) of each segment (see FIG. 2) Further, the server 1 divides each segment SG into fixed blocks BLf, . . . and an variable block BLo according to the download time d_{b} (or playout time dₐ) of the fixed block and the download time bₙ₂ (or the playout time aₙ₂) of the variable block (see FIG. 2).

Subsequently, the server 1 creates the original data of the contents CN into meta contents for each segment SG in block BL units (see FIG. 11 and FIG. 12). Also the server 1 creates the meta contents data in block BL units into packets (see FIG. 11).

Then the server 1 stream-distributes the packets in block units to the personal computer 2 via the Internet I for each segment SG (see FIG. 1).

Media division for the contents CN and FEC encoding need not be performed for each stream-distribution, since once is sufficient.

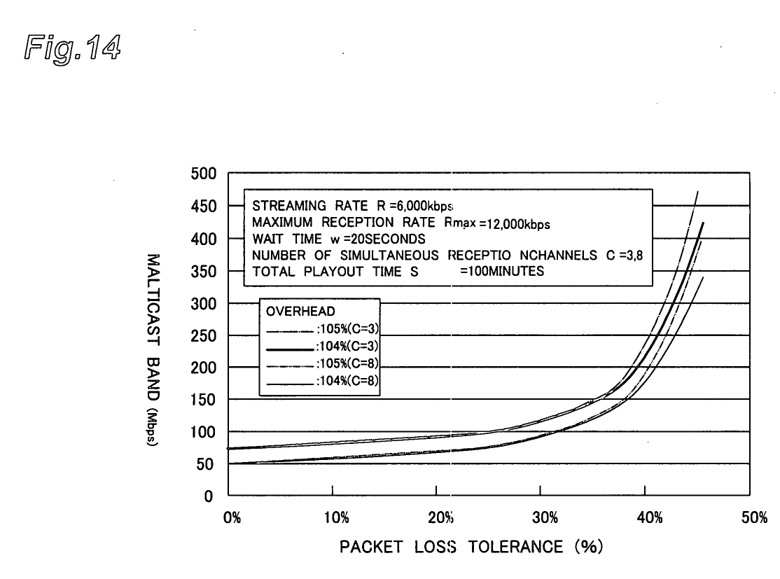

FIG. 14 shows the changes of the multicast band according to the packet loss tolerance depending on the difference of the overhead e. The conditions here are streaming rate R 6000 kbps, total playout time S 100 minutes, maximum reception rate Rₘₐₓ 12000 kbps, wait time w 20 seconds, and the number of simultaneous reception channels is 3 or 8. The overhead e is assumed to be 105% and 104%. As FIG. 14 shows, the multicast bands (thick solid line and thin solid line) when the overhead e is 104% are smaller than the multicast bands (one dot chain line and two dot chain line) when the overhead e is 105%. This tendency becomes more obvious as the packet loss tolerance L increases in the server 1. The overhead e₁ of the fixed block is set to 104%, and the overhead e for each segment is optimized so as to be as close as possible to 104%. Therefore the multicast band in the case of the overhead e which is optimized for each segment by the server 1 becomes smaller than the multicast band in the case of a conventional overhead e (e.g. 105%), which is uniformly set to a safe value.

According to this server 1, the fixed block size Bₛ is set and the overhead e₂ of an variable block is determined for each segment so that the overhead e₁ of the fixed block becomes the minimum, and the overhead e is set for each segment, by which the overhead e is optimized according to the size of the segment (also to the size of the contents CN) Therefore unnecessary redundant data is not generated, data volume when the contents CN is distributed decreases, and the multicast band (transmission band) can be decreased. In other words, according to this server 1, media division is optimized, and stream-distribution combining media division and meta contents creation can be implemented with a smaller transmission band than prior art.

The embodiment of the present invention has been described above, but the present invention is not limited to the above embodiment, but can be embodied in various forms.

For example, the present invention is applied to the multicast type VOD in the present embodiment, but can also be applied to a unicast type and broadcast type, as well as to a cinema complex.

In the present embodiment, the media division section and the FEC encoder are constructed by software, but may be constructed by hardware.

In the present embodiment, the overhead and the playout time are computed using the Newton-Raphson method, but may be determined using other numerical analysis methods, such as a bisection algorithm.

According to the present invention, the overhead can be optimized according to the data size, and the data volume during the transmission of the contents combining media division and meta contents creation can be decreased.

What is claimed is:

1. A transmission data generation method, comprising:
a fixed block size setting step of setting the size of a fixed block based on the overhead;
a segment size calculation step of calculating the size of a segment for each segment of the contents based on the size of the said fixed block;
a segment division step of dividing the contents into segments according to the calculated size of said segment;
a block division step of dividing said divided segment into blocks; and
a meta contents creation step for creating the contents into meta contents by adding overhead for each one of said divided blocks,
wherein the overhead is set for each segment of the contents based on the overhead in said fixed block.

2. A transmission data generation method, comprising:
a fixed block size setting step of setting the size of a fixed block based on the overhead;
a fixed block playout time calculation step of calculating the playout time of said fixed block based on the size of said fixed block;
a playout time calculation step of calculating the playout time of a segment for each segment of the contents based on the playout time of said fixed block;
a transmission time calculation step of calculating the transmission time of a segment for each segment of the contents based on the calculated playout time of the segment;
a segment division step of dividing the contents into segments according to said calculated transmission time of the segment;
a block division step of dividing said divided segment into blocks; and
a meta contents creation step for creating the contents into meta contents by adding overhead for each one of said divided blocks,
wherein the overhead is set for each segment of the contents based on the overhead in said fixed block.

3. The transmission data generation method according to claim 2, wherein in said fixed block size setting step, the size of said fixed block is set so that the overhead becomes a small value.

4. The transmission data generation method according to claim 3, further comprising an variable block setting step of determining the size or playout time of an variable block which cannot be divided by said fixed block and the overhead of the variable block for each segment of the contents when the size of the segment is not an integer multiplication of the size of the fixed block,
wherein when the size of the segment is not an integer multiplication of the size of the fixed block, the overhead for each segment is set based on the overhead in said fixed block and the overhead of the variable block of said segment.

5. The transmission data generation method according to claim 4, further comprising:
a fixed block transmission time calculation step of calculating the transmission time of said fixed block based on the playout time of said fixed block;
a fixed block count calculation step of calculating the number of fixed blocks included in the segment for each segment of the contents based on the transmission time of said segment and the transmission time of said fixed block; and
a total fixed block playout time calculation step of calculating the playout time of all the fixed blocks included in the segment for each segment of the contents based on said calculated number of fixed blocks and the playout time of said fixed block,
wherein in said playout time calculation step, the playout time of all the fixed blocks included in said segment is regarded as the playout time of the segment for each segment of the contents if the size of the segment is an integer multiplication of the size of the fixed block, and if the size of the segment is not an integer multiplication of the size of the fixed block, the playout time of the segment is calculated based on the playout time of an variable block of said segment and the playout time of all the fixed blocks included in said segment.

6. The data generation method according to claim 5, wherein in said variable block setting step, the product of the playout time of said variable block and the overhead in said variable block is determined for each segment of the contents using the playout time of all the fixed blocks included in said segment and transmission time of said segment, and the playout time of said variable block and the overhead in said variable block are determined from said product using a predetermined numerical analysis method.

7. A transmission data generation equipment, comprising:
time calculation means which sets the size of a fixed block based on the overhead, calculates the playout time of the fixed block based on the size of said fixed block, calculates the playout time of a segment for each segment of the contents based on the playout time of said fixed block, and calculates the transmission time of a segment based on the calculated playout time of the segment;
division means which divides the contents into segments according to the transmission time of the segment calculated by said time calculation means and divides said divided segments into blocks; and
meta contents means for converting the contents into meta contents by adding the overhead for each block divided by said division means,
wherein said time calculation means sets the overhead for each segment based on the overhead in said fixed block.

8. The transmission data generation equipment according to claim 7, wherein said time calculation means sets the size of said fixed block so that the overhead becomes a small value.

9. The transmission data generation equipment according to claim 8, wherein when the size of a segment is not an integer multiplication of the size of the fixed block, said time calculation means determines the playout time of an variable block which cannot be divided by said fixed block and the overhead in the variable block, and sets said overhead for each segment based on the overhead in said fixed block and the overhead in the variable block of said segment.
